(19) United States
(12) Patent Application Publication
(10) Pub. No.: US 2023/0239559 A1
(43) Pub. Date: Jul. 27, 2023

(54) ACTIVATING LIGHT SOURCES FOR OUTPUT IMAGE

(71) Applicant: Hewlett-Packard Development Company, L.P., Spring, TX (US)

(72) Inventors: Stephen M. DeRoos, Vancouver, WA (US); Rafael Dal Zotto, Porto Alegre (BR); Gareth R. Westlake, Spring, TX (US)

(73) Assignee: Hewlett-Packard Development Company, L.P., Spring, TX (US)

(21) Appl. No.: 18/002,610

(22) PCT Filed: Jun. 26, 2020
(86) PCT No.: PCT/US2020/039779

§ 371 Date: Dec. 20, 2022

(51) Int. Cl. H04N 23/56; G03B 17/06; H04N 23/60; H04N 23/95; H04N 23/84

(52) U.S. Cl. CPC H04N 23/56; G03B 17/06; H04N 23/64; H04N 23/95; H04N 23/84

(57) ABSTRACT

In some examples, a computing device can include a processor resource and a non-transitory memory resource storing machine-readable instructions stored thereon that, when executed, cause the processor resource to: instruct an imaging device to capture an input image, determine image properties of the input image, activate a portion of a plurality of light sources based on a physical location of the plurality of light sources and the determined image properties of the input image, and instruct the imaging device to capture an output image when the portion of the plurality of light sources are activated.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry of otherwise bring with the computing device with while in a mobile setting. These computing devices can be utilized to provide video conferencing between computing devices and/or generate images that can be transferred between computing devices.

### BRIEF DESCRIPTION OF THE DRAWINGS

FIG. 1 is an example of a system including a device for activating light sources for output images.

FIG. 2 illustrates an example of a memory resource storing instructions for activating light sources for increasing an image quality of output images.

FIG. 3 illustrates an example of a system including a computing device for activating light sources for output images based on a subject.

FIG. 4 illustrates a block diagram of an example system for activating light sources for output images based on a subject.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, networking device (e.g., router, switch, etc.), and/or a mobile device (e.g., a smart phone, tablet, personal digital assistant, smart glasses, a wrist-worn device, etc.), among other types of computing devices. As used herein, a mobile device refers to devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

In some examples, the computing devices can instruct imaging devices to capture images. As used herein, the term “imaging device” is a device that can capture or record visual images. In some examples, the imaging device can include a camera or similar device to capture images. For example, the imaging device can be a video camera to record a plurality of images that can be in a video format. Although video cameras are utilized as examples herein, the disclosure is not so limited.

In some examples, the computing device can instruct the imaging device to capture images that can be transmitted to other computing devices. For example, the computing device can instruct a video camera to capture a video image of a presentation and the video image can be provided to a remote computing device (e.g., different computing device, server, etc.) to be displayed at the remote computing device. In some examples, the quality of the images captured by the computing device can affect the value of the captured images to a user. For example, a user can utilize the computing device to generate images that are distributed to a particular audience. In this example, a relatively higher image quality may be result in a relatively higher viewership of the particular audience compared to a relatively lower image quality. In another example, an image captured during a video conference between users can result in higher positive feedback when the image quality is relatively higher.

The present disclosure relates to increasing image quality utilizing a plurality of light sources positioned around a display of the computing device and/or image correction. Utilizing a plurality of light sources positioned around a display can allow the light sources to be activated and/or deactivated based on luminosity at portions of a subject and a position of the plurality of light sources. For example, a user can be a subject of captured images. In this example, portions of the subject can be identified as having a luminosity below a threshold luminosity. In this example, a portion of light sources directed at the portions can be activated or altered to have a relatively higher brightness level based on the location of the light sources to direct more light toward the portions of the subject that are below the threshold luminosity. In this way, an output image can be captured when the luminosity at the subject is equal or greater than the threshold luminosity to increase the quality of the images provided to a remote computing device. In some examples, the luminosity at the subject can be monitored throughout an image capturing period to increase the image quality of the output image continuously even when the subject or surrounding light changes.

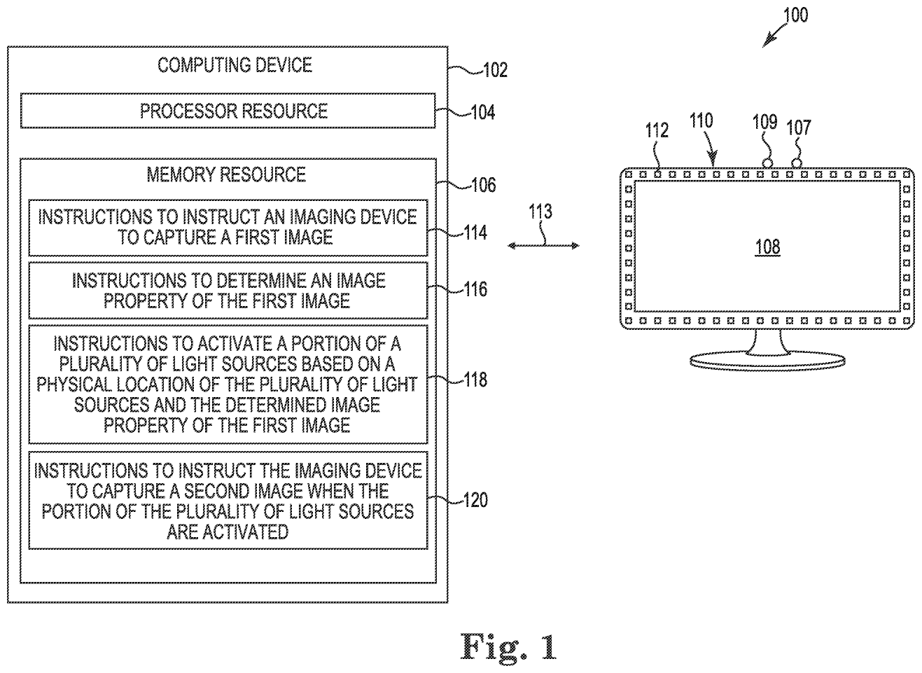

FIG. 1 is an example of a system 100 including a device 102 for activating light sources 112 for output images. In some examples the device 102 can be a computing device that includes a processor resource 104 communicatively coupled to a memory resource 106. As described further herein, the memory resource 106 can include instructions 114, 116, 118, 120 that can be executed by the processor resource 104 to perform particular functions. In some examples, the device 102 can be associated with display 108. For example, the device 102 can be utilized to display images on the display 108. In some examples, the device 102 can be local or remote to the display 108. For example, the device 102 can be a cloud resource that is remote from the display 108.

In some examples, the device 102 can be communicatively coupled to the display 108 through a communication path 113. As used herein, a communication path, such as communication path 113, refers to a connection that allows signals to be transferred between devices. In these examples, the signals can be utilized to provide communication between different devices and/or components within a device. For example, the device 102 can utilize the communication path 113 to instruct an imaging device 109 coupled to the display 108 to capture an input image. In another example, the device 102 can provide an image to be displayed on the display 108. In some examples, the device 102 and the display 108 can be separate and distinct devices, however, the device 102 can be incorporated as a portion of the display 108. For example, the device 102 can include a separate physical enclosure than the enclosure 110. However, in other examples, the device 102 can be positioned within the enclosure 110 of the display 108. That is, the device 102 can be hardware that is enclosed within the enclosure 110 of the display 108.

In some examples, the display 108 can include an enclosure 110. In some examples, the enclosure 110 can be utilized to protect the display 108 by providing structural support for the display 108. For example, the enclosure 110 can cover edges of the display 108 to protect the display area. In this example, the enclosure 110 can also extend over a rear surface to protect electronics associated with the display (e.g., printed circuit boards, power supplies, etc.). In some examples, the edges of the display 108 can be covered by a bezel or other structural feature. In some examples, the enclosure 110 can include the bezel surrounding the edges of the display 108 and a case coupled to the bezel that covers a portion behind the display 108 that can include computing hardware and/or light sources to generate images on the display 108.

In some examples, the display 108 can be coupled to an imaging device 109. In some examples, the imaging device 109 can be a separate device from the display 108. For example, the imaging device 109 can be a video camera or webcam that can capture still images and/or video images of an area parallel to the display 108. In this example, the imaging device 109 can be coupled to the enclosure 110 through a mounting mechanism. As used herein, a mounting mechanism can include a physical structure to couple a first device to a second device. In other examples, the imaging device 109 can be embedded within the enclosure 110 and/or frame that surrounds the display 108. In some examples, the captured images of the imaging device 109 can be displayed on the display 108 and/or transmitted to be displayed or utilized by a remote device, such as a remote computing device or remote display.

In some examples, the system 100 can include a plurality of light sources 112. In some examples, the plurality of light sources 112 can include devices that are capable of generating light. For example, the plurality of light sources 112 can include, but are not limited to: light emitting diodes (LEDs), incandescent lamps, fluorescent lamps, organic light emitting diodes (OLEDs), among other types of light generating devices. In some examples, the LEDs can be white LEDs that can be altered between a relatively cold white color to a relatively warm white color. In some examples, the LEDs can be red blue and green (RBG) LEDs that can change between different colors. In some examples, the plurality of light sources 112 can be individually controlled and/or individually altered based on an input image. For example, a first light source of the plurality of light sources 112 can be activated to generate light while a second light source of the plurality of light sources 112 can be deactivated to not generate light. In this way, as described further herein, portions of the light sources 112 can be activated or altered to a different tone or color based on a corresponding portion of an input image.

In some examples, the physical location of the plurality of light sources 112 can be altered when the plurality of light sources 112 are not embedded or permanently coupled to the enclosure 110. In these examples, the device 102 can include instructions to determine a physical location of the plurality of light sources 112 and/or determine a direction of light emitted by the plurality of light sources 112. In some examples, determining the physical location and/or direction of emitted light can be determined by activating and/or deactivating particular light sources and utilize the imaging device 109 to identify the physical location of the light sources 112 and/or the direction of the light sources 112. In a similar way, the device 102 can be utilized to determine a brightness at different distances for each of the plurality of light sources 112. For example, the imaging device 109 can capture images that utilize different brightness levels of the plurality of light sources 112 to determine a brightness increase at different distances for each of the plurality of light sources 112. In this way, the device 102 can utilize the brightness increases at different distances to determine brightness levels of the plurality of light sources based on a luminosity at the subject and distance of the subject from the plurality of light sources 112.

As described herein, the device 102 can be utilized to control functions of the monitor 108, imaging device 109, and/or the plurality of light sources 112. The device 102 can be a component of a computing device such as a processor, an application specific integrated circuit (ASIC), a field programmable gate array (FPGA), a metal-programmable cell array (MPCA), or other combination of circuitry and/or logic to orchestrate execution of instructions 114, 116, 118, 120. In other examples, the device 102 can be a computing device that can include instructions 114, 116, 118, 120 stored on a machine-readable medium (e.g., memory resource 106, non-transitory computer-readable medium, etc.) and executable by a processor resource 104. In a specific example, the device 102 is a computing device that utilizes a non-transitory computer-readable medium storing instructions 114, 116, 118, 120 that, when executed, cause the processor resource 104 to perform corresponding functions.

In some examples, the device 102 can include instructions 114 that can be executed by a processor resource 104 to instruct an imaging device 109 to capture an input image. As described herein, the imaging device 109 can include a camera or device that can capture images such as still images and/or video images. In other examples, the display 108 can include an ambient light sensor 107 to detect the ambient light within an area of the subject. In these examples, a camera to capture an image can be utilized with the ambient light sensor 107 to determine a luminosity of the area or luminosity at the features of the area. In some examples, the imaging device 109 can be instructed to capture an image that can be utilized to improve an image that is transmitted as an output image. As used herein, an input image refers to an image that is captured to determine image properties. For example, the imaging device 109 can capture an input image to determine a luminosity level at a subject captured by the input image. In this example, the determined image properties can be utilized to increase a quality of the image and/or increase a quality of the subject within the image. As described herein, a relatively higher image quality can increase a value of the image generated by the imaging device 109.

In some examples, the device 102 can include instructions 116 that can be executed by a processor resource 104 to determine image properties of the input image. As used herein, the term “image properties” refer to visual properties of an image. For example, image properties can include, but are not limited to: brightness, tone, contrast, color, clarity, among other properties that can effect an image quality. In some examples, the image properties can indicate that a greater quantity of light (e.g., greater quantity of lumens, greater luminosity, etc.) can increase an image quality. In these examples, the image properties can indicate that a lower quantity of light can increase an image quality. In these examples, the quantity of light can be altered by altering a state of the plurality of light sources 112.

As used herein, a state of a light source refers to information related to a quantity of light emitted, a color of light emitted, a tone of light emitted, and/or other features of the light emitted by the light source. For example, a state of a first light source can be activated or deactivated. In this example, the activated state can correspond to a state when a light source is emitting light and the deactivated state can correspond to a state when the light source is not emitting light. In another example, the state of a first light can include a first color or tone emitted by the first light while the state of a second light can include a second color or tone emitted by the second light. Thus, the state of the plurality of light sources 112 can quantify or describe the light properties of the light emitted by the plurality of light sources 112.

In some examples, the input image can be divided into a plurality of portions. As used herein, a portion of an image refers to a segment that includes a particular quantity of pixels within a larger image. For example, a first portion of the image can correspond to a right side of the image and a second portion of the image can correspond to a left side of the image when the image is split into two sides by a dividing line. In some examples, the plurality of portion of the image can be individually analyzed to determine the corresponding image properties of the plurality of portions.

As described herein, the plurality of portions can each have different image qualities based on the surroundings. For example, the image quality of a first portion can be affected by sunlight or exterior light that is directed toward the first portion. In this example, a second portion may not be affected to the same extend as the first portion. Thus, additional lighting toward the first portion may not increase the image quality of the first portion while providing additional lighting toward the second portion may increase the image quality of the second portion.

In this way, the device 102 can determine a corresponding portion of the plurality of light sources 112 for each of the plurality of portions of the image. Thus, the device 102 can activate corresponding light sources 112 to portions of the image where an increase in the quantity of light may increase the image quality. In addition, the device 102 can deactivate corresponding light sources 112 to portion of the image where a decrease in the quantity of light may increase the image quality. In a similar way, the device 102 can alter a state (e.g., brightness, color, tone, etc.) of the portion of corresponding light sources 112 based on the image properties of the corresponding portion of the input image.

In some examples, the device 102 can include instructions 118 that can be executed by a processor resource 104 to activate a portion of a plurality of light sources 112 based on a physical location of the plurality of light sources and the determined image properties of the input image. As described herein, the device 102 can activate a portion of the plurality of light sources 112 based on image properties of a corresponding portion of the input image and/or sensor data from an ambient light sensor 107. For example, the device 102 can determine portions of the input image that have a luminosity or brightness level that is below a threshold brightness. In this example, the device 102 can activate portions of the plurality of light sources 112 that correspond to the determined portions that have a brightness level below the threshold brightness. In other examples, the processor resource 104 can activate a plurality of portions of the plurality of light sources 112. For example, a first portion of light sources 112 physically located at a first corner of the enclosure 110 and a second portion of light sources 112 physically located at a second corner of the enclosure 110 can be activated simultaneously based on the determined image properties.

In some examples, a second or different input image can be captured by the imaging device 109 to determine portions of the second input image that are below the threshold brightness. In these examples, the device 102 can activate, deactivate, and/or alter a state of a portion of the plurality of light sources 112 that correspond to the determined portions of the second input image that are below the threshold brightness or other image quality threshold. As used herein, the image quality threshold refers to an upper and/or lower thresholds of image properties (e.g., color, brightness, tone, contrast, etc.). In some examples, the device 102 can utilize a plurality of image quality thresholds that can be altered utilizing the plurality of light sources 112. In some examples, the device 102 can utilize a feedback loop for the plurality of image quality thresholds by continuously generating input images, altering the state of the plurality of light sources 112, and testing a newly generated input image to determine when the captured input image is within particular image quality ranges (e.g., below or equal to upper thresholds, above or equal to lower thresholds, etc.).

In some examples, the device 102 can include instructions 120 that can be executed by a processor resource 104 to instruct the imaging device to capture an output image when the portion of the plurality of light sources 112 are activated. As described herein, an output image (e.g., image to be utilized for a task, etc.) can be captured when the portion of the plurality of light sources 112 such that the output image is within particular image quality ranges for different image properties. In some examples, the portion of the plurality of light sources 112 were activated by the device 102 to increase the image quality of corresponding portions of the input image. That is, the activation of the portion of the plurality of light sources 112 and/or the deactivation of a remaining portion of the plurality of light sources 112 can increase an overall image quality such that the imaging device 109 can capture an output image to be utilized. As used herein, an output image refers to an image that is to be displayed. For example, the output image can be a still image or video image that is transmitted to a database or transmitted to a remote device.

In some examples, the device 102 can include instructions that can be executed by a processor resource 104 to transmit the output image to a different computing device utilizing a communication path and restrict the input image from being transmitted to the different computing device. In some examples, the device 102 can utilize the output image for different image applications. For example, the device 102 can send the output image to an application that can be used for a video conference with a remote device. In other examples, the output image can be utilized and stored as a single captured image without storing the input image. In this way, the relatively lower quality input image is not distributed while the relatively higher quality output image is provided or distributed to other devices. For example, a proxy camera, virtual camera, and/or clone camera can be utilized to capture the input image and a real camera can be utilized to capture the output image (e.g., real image, original image, etc.). As used herein, a proxy camera, virtual camera, and/or clone camera refer to devices that capture proxy images of an area or subject. As used herein, a proxy image includes an auxiliary copy of an original image that may include a relatively lower resolution or fewer image properties than the original image. In this way, the quality of the images provided to remote devices can be a relatively higher quality compared to other systems.

In some examples, restricting the input image from being transmitted to the different computing device can include storing the input image as a proxy image of the output image. In this way, the input image can be utilized for analysis of lighting on the subject and prevented from being transferred to a different computing device since the input image may not include image properties that are above corresponding image property thresholds.

In some examples, the device 102 can include instructions that can be executed by a processor resource 104 to determine an intensity and direction for the plurality of light sources 112 based on the distance of the subject from the imaging device and the identified shadowing on the subject. In some examples, the device 102 can utilize the input image to determine a distance between the plurality of light sources 112 and a subject within the input image. As used herein, a subject of the image refers to a focus of the image. For example, the subject of an image including a human user can be the human user. In another example, the subject of the image can be a particular object within the image. In some examples, the device 102 can utilize a subject identification application to identify the subject of an input image. For example, the subject identification application can identify different objects and select an object that takes up a largest quantity of pixels within the image. In other examples, the subject can be selected through a user input by selecting a particular object or portion of the image through a user interface.

In some examples, the device 102 can identify shadowing on the subject utilizing the input image and a brightness level of the plurality of portions of the input image. In these examples, the shadowing on the subject can be areas or pixels representing the subject that are below a brightness threshold as described herein. In this way, the device 102 can identify the shadowing on the subject and identify that corresponding light sources 112 are to be activated to remove or improve the shadowing. In these examples, the device 102 can determine an intensity of the light generated by the light sources 112 to identify a potential effect of the light on the subject and/or identified shadowing on the subject. In addition, the device can determine the direction of the light from the plurality of light sources 112 based on a physical location or position of the plurality of light sources 112 with respect to the subject.

In some examples, the device can utilize the identified intensity of the plurality of light sources 112 and/or the direction of the plurality of light sources 112 to identify a portion of light sources 112 to activate, a portion of light sources 112 to deactivate, and/or a state of the portion of activated light sources. In this way, the device 102 can alter a state of a portion of the light sources 112 to increase the brightness level and/or image quality of the identified shadowing on the subject or other areas of the image.

In some examples, the device 102 can determine an intensity to activate the portion of light sources 112 based on the luminosity at the subject. In some examples, the device 102 can include instructions that can be executed by a processor resource 104 to activate the portion of the plurality of light sources 112 to the determine intensity. In some examples, the portion of the plurality of light sources 112 are selected based on a direction of light emitted from the portion of the plurality of light sources 112. As described herein, the direction of the light emitted from the plurality of light sources 112 can be fixed based on the position or physical location of the plurality of light sources 112. In other examples, the direction of the plurality of light sources 112 can be altered to different physical locations. For example, a light source 112 can be moved from a first side of the display 108 to a second side of the display 108. In this example, the light sources 112 may be removable and physically moved from a first location to a second location.

In some examples, the device 102 can include instructions that can be executed by a processor resource 104 to alter a state of light sources utilized by the display 108 to generate images. For example, the plurality of light sources 112 can be altered based on the luminosity at the subject and in combination, the light sources utilized by the display 108 to generate images can also be altered based on the luminosity at the subject. As used herein, light sources utilized by the display 108 refer to backlights and/or pixels of the display 108. In some examples, a state (e.g., color, tone, brightness, etc.) of the light sources utilized by the display 108 can be altered based on the image properties of the input image as described herein.

In some examples, the device 102 can include instructions that can be executed by a processor resource 104 to alter a color of the portion of the plurality of light sources 112 based on a determined color tone of a subject. In some examples, the device 102 can be utilized to identify a color tone of a subject. As used herein, a color tone of a subject refers to a hue, tint, tone, shade, and/or color of the subject of the input image. In some examples, different color tones can alter an effectiveness of a particular quantity of light added or removed from the subject. For example, a relatively darker color tone may need a relatively higher quantity of light to be emitted by the portion of the plurality of light sources 112 compared to a relatively lighter color tone.

In this way, the device 102 can alter the state (e.g., color, tone, brightness, etc.) of the plurality of light sources 112 based on the color tone of the subject to increase an image quality of the subject. In some examples, the device 102 can include instructions to alter a color tone of a portion of the plurality of light sources 112 to a color tone based on the color tone of the subject. For example, the color tone of the portion of light sources 112 can be adjusted to a designated or determined color tone based on the color tone of the subject. In this way, image correction instructions and the plurality of light sources 112 can increase the quality of an image based on the color tone of the subject.

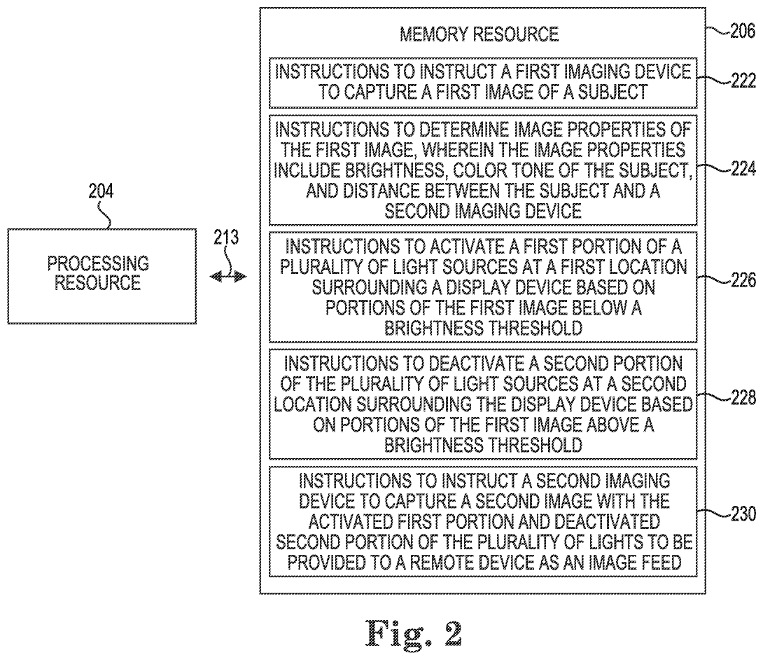

FIG. 2 illustrates an example of a memory resource 206 storing instructions for activating light sources for increasing an image quality of output images. In some examples, the memory resource 206 can be a part of a computing device or controller that can be communicatively coupled to a computing system that includes a display, plurality of light sources, and/or imaging devices. For example, the memory resource 206 can be part of a device 102 as referenced in FIG. 1 and communicatively coupled to a display 108 as referenced in FIG. 1. In some examples, the memory resource 206 can be communicatively coupled to a processor resource 204 that can execute instructions 222, 224, 226, 228, 230 stored on the memory resource 206. For example, the memory resource 206 can be communicatively coupled to the processor resource 204 through a communication path 213. In some examples, a communication path 213 can include a wired or wireless connection that can allow communication between devices.

The memory resource 206 may be electronic, magnetic, optical, or other physical storage device that stores executable instructions. Thus, non-transitory machine readable medium (e.g., a memory resource 206) may be, for example, a non-transitory MRM comprising Random-Access Memory (RAM), an Electrically-Erasable Programmable ROM (EEPROM), a storage drive, an optical disc, and the like. The non-transitory machine readable medium (e.g., a memory resource 206) may be disposed within a controller and/or computing device. In this example, the executable instructions 222, 224, 226, 228, 230 can be “installed” on the device. Additionally, and/or alternatively, the non-transitory machine readable medium (e.g., a memory resource) can be a portable, external or remote storage medium, for example, that allows a computing system to download the instructions 222, 224, 226, 228, 230 from the portable/external/remote storage medium. In this situation, the executable instructions may be part of an “installation package”. As described herein, the non-transitory machine readable medium (e.g., a memory resource 206) can be encoded with executable instructions for altering light sources to alter a luminosity at a subject.

The instructions 222, when executed by a processing resource such as the processing resource 204, can include instructions to instruct a first imaging device to capture a first image of a subject. In some examples, the first imaging device can be a camera or similar device to capture images. In some examples, the first imaging device can include an ambient light sensor (e.g., ambient light sensor 107 as referenced in FIG. 1, etc.) to determine a quantity of ambient light within an area. As described herein, the quantity of ambient light can be utilized with the first image of the subject to determine a luminosity at the subject. In some examples, the first imaging device can be utilized to capture input images that can be analyzed to determine a portion of the plurality of light sources to activate and/or determine a state of the portion of the plurality of light sources.

The instructions 224, when executed by a processing resource such as the processing resource 204, can include instructions to determine image properties of the first image, wherein the image properties include brightness, color tone of the subject, and distance between the subject and a second imaging device. As described herein, the image captured by the first imaging device can be utilized as an input image. As described herein, the input image can be analyzed to determine image properties of the input image to determine a brightness of a plurality of portions of the image. For example, the input image can be split into a plurality of portions and each of the plurality of portions can be analyzed individually to determine a brightness level of each of the plurality of portions of the input image. As described herein, the brightness level of the plurality of portions can be compared to a threshold brightness level to identify portions of the input image that are below a lower brightness threshold.

In addition, the color tone of the subject can be determined from the input image. As described herein, the subject can be the focus of the input image. In some examples, the color tone of the subject can alter an effectiveness of a quantity of light generated by a light source. For example, a greater quantity of light may be needed to increase a brightness level or luminosity of a relatively darker subject above a threshold brightness level compared to a relatively lighter subject. In addition, the distance of the subject from a second imaging device and/or a distance of the subject and the plurality of light sources can alter an effectiveness of the quantity of light generated by the plurality of light sources. For example, a greater distance between the plurality of light sources and a subject may result in needing a greater quantity of light to be emitted by the plurality of light sources to increase a brightness level at the subject compared to a lower distance.

The instructions 226, when executed by a processing resource such as the processing resource 204, can include instructions to activate a first portion of a plurality of light sources at a first location surrounding a display device based on portions of the first image below a brightness threshold. As described herein, the plurality of light sources can be split into a plurality of portions that correspond to particular portions of the input image. In this way, a portion of the input image can correspond to a portion of the plurality of light sources. In this example, a state of a particular portion of the plurality of light sources can be altered based on the portion of the input image to be altered. For example, a portion of the input image can be identified as being below a brightness threshold. In this example, a corresponding portion of light sources can be activated and/or altered to a particular state to increase the brightness level at or above the brightness threshold

The instructions 228, when executed by a processing resource such as the processing resource 204, can include instructions to deactivate a second portion of the plurality of light sources at a second location surrounding the display device based on portions of the first image above a brightness threshold. As described herein, the plurality of light sources can correspond to particular portions of the input image. In some examples, a portion of the input image can be identified as having a brightness level that is above a brightness threshold. In these examples, a portion of the plurality of light sources can be deactivated or altered to a different state to lower the brightness level of the identified portions.

The instructions 230, when executed by a processing resource such as the processing resource 204, can include instructions to instruct a second imaging device to capture a second image with the activated first portion and deactivated second portion of the plurality of lights to be provided to a remote device as an image feed. In some examples, the altered states of the plurality of light sources can be implemented to alter the brightness levels of the input image to increase the image quality of the input image, When the image quality of the input image exceeds an image quality threshold, the second imaging device can be utilized to capture an output image that can be utilized as a final image.

In some examples, the first imaging device can be different or separate from the second imaging device. For example, the first imaging device can include particular functions that may not be available to the second imaging device. In this example, the first imaging device can utilize a depth mask to identify the distance of a subject from the first imaging device and/or second imaging device. In other examples, the first imaging device can be the same physical imaging device as the second imaging device. For example, the first imaging device can be a camera in a first state with a first set of functions and the second imaging device can be the same camera in a second state with a second set of functions. In this way, the first imaging device can prioritize functions for identifying image properties and the second imaging device can prioritize functions for generating high quality images to be utilized as final images. As used herein, a final image refers to an image that is utilized for an application (e.g., video conference, video upload, etc.).

In some examples, the memory resource 206 can include instructions to determine a luminosity at a plurality of locations of the subject. As described herein, determining a luminosity at a plurality of locations of the subject can include determining a brightness level of a plurality of pixels that represent the subject. In this way, shadowing or other issues with lighting can be identified and corresponding light sources for the portions can be altered to adjust the luminosity at the subject. In some examples, the memory resource 206 can include instructions to determine a brightness and color of the first portion of the plurality of light sources based on the luminosity at the plurality of locations of the subject. As described herein, the luminosity at the subject can be affected by a number of factors, including, but not limited to: ambient light, subject color tone, direction of ambient light, among other factors that can affect brightness levels.

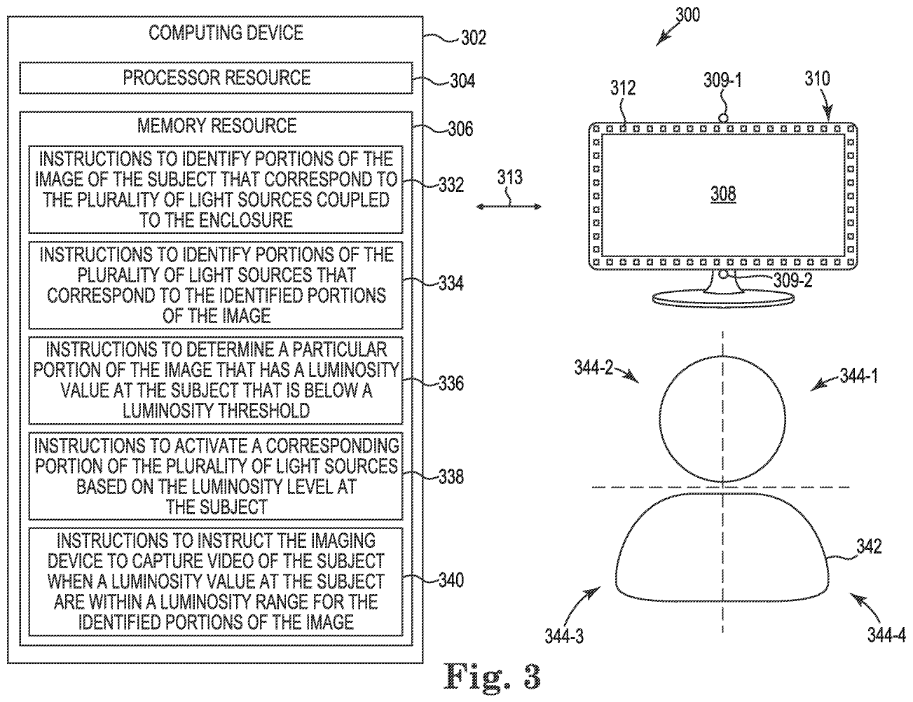

FIG. 3 illustrates an example of a system 300 including a computing device 302 for activating light sources for output images based on a subject 342. In some examples the computing device 302 can be a computing device that includes a processor resource 304 communicatively coupled to a memory resource 306. As described further herein, the memory resource 306 can include instructions 332, 334, 336, 338, 340 that can be executed by the processor resource 304 to perform particular functions.

In some examples, the system 300 can include a display 308 that includes a first imaging device 309-1 and a second imaging device 309-2. As described herein, the first imaging device 309-1 and the second imaging device 309-2 can be separate imaging devices. In some examples, the first imaging device 309-1 can be utilized to capture input images for analyzing image properties of an input image of a subject 342. In these examples, the second imaging device 309-2 can be utilized to capture output images to be utilized by the computing device 302. Although the first imaging device 309-1 is positioned on a top edge of the monitor 308 and the second imaging device 309-2 is positioned on a bottom edge of the monitor, the disclosure is not so limited. For example, the first imaging device 309-1 and/or the second imaging device 309-2 can be positioned or coupled to different locations of the display 308.

In some examples, the device 302 can split the input image of the subject 342 into a plurality of portions 344-1, 344-2, 344-3, 344-4. In these examples, the device 302 can determine a portion of light sources 312 that correspond to each of the plurality of portions 344-1, 344-2, 344-3, 344-4. In this way, a corresponding portion of light sources 312 can be activated, deactivated, or altered to a different state based on a luminosity of each of the plurality of portions 344-1, 344-2, 344-3, 344-4.

In some examples, the computing device 302 can include instructions 332 that can be executed by a processor resource 304 to identify portions 344-1, 344-2, 344-3, 344-4 of the image of the subject 342 that correspond to the plurality of light sources 312 coupled to the enclosure 310. As described herein, a first imaging device 309-1 can be utilized to capture input images. In some examples, the input images can include a depth mask to determine a distance between the subject 342 and the plurality of light sources 312. For example, the first imaging device 309-1 can generate a depth mask for the input image and utilize the depth mask to identify pixels associated with the subject 342 and the corresponding distance of the subject 342.

As described herein, the computing device 302 can split the input image into a plurality of portions 344-1, 344-2, 344-3, 344-4. Although four portions 344-1, 344-2, 344-3, 344-4 are illustrated, the disclosure is not so limited. For example, a plurality of additional portions can be utilized. In some examples, the plurality of portions 344-1, 344-2, 344-3, 344-4 can be utilized to determine corresponding portions of the plurality of light sources 312 that can be utilized to increase or decrease a quantity of light within the corresponding portion of the plurality of portions 344-1, 344-2, 344-3, 344-4.

In some examples, the computing device 302 can include instructions 334 that can be executed by a processor resource 304 to identify portions of the plurality of light sources 312 that correspond to the identified portions 344-1, 344-2, 344-3, 344-4 of the image. As described herein, the identified portions 344-1, 344-2, 344-3, 344-4 can be utilized to determine portions of the plurality of light sources 312 that can be utilized to alter a brightness of a particular portion of the identified portions 344-1, 344-2, 344-3, 344-4. In this way, a brightness level can be determined for each of the plurality of portions 344-1, 344-2, 344-3, 344-4 and a state of a corresponding portion of the plurality of light sources 312 can be altered based on the determined brightness level.

In some examples, the computing device 302 can include instructions 336 that can be executed by a processor resource 304 to determine a particular portion of the image that has a luminosity value at the subject 342 that is below a luminosity threshold. The luminosity threshold can include a brightness level or brightness range that corresponds to a relatively high image quality. In this way, portions of the plurality of portions 344-1, 344-2, 344-3, 344-4 can be identified as having a relatively low brightness level and/or relatively low image quality and the computing device 302 can alter a state of a corresponding portion of the plurality of light sources 312 to adjust the brightness level of the identified portions of the image.

In some examples, the computing device 302 can include instructions 338 that can be executed by a processor resource 304 to activate a corresponding portion of the plurality of light sources 312 based on the luminosity level at the subject 342. As described herein, the corresponding portion of the plurality of light sources 312 can include light sources 312 that are directed toward a portion of the plurality of portions 344-1, 344-2, 344-3, 344-4 that are identified as having a luminosity below the luminosity threshold. In this way, light sources 312 that can alter the luminosity of the identified portion of the subject 342 can be activated or altered.

In some examples, the computing device 302 can include instructions 340 that can be executed by a processor resource 304 to instruct the imaging device 309-2 to capture video of the subject 342 when a luminosity value at the subject 342 are within a luminosity range for the identified portions 344-1, 344-2, 344-3, 344-4 of the image. As described herein, a luminosity value at the subject 342 can include a brightness level of a pixel associated with the subject 342. That is, a boundary of the subject 342 can be identified and pixels within the boundary of the subject 342 can be utilized to identify portions of the subject 342 that are outside a luminosity range (e.g., below a luminosity threshold, above a luminosity threshold, etc.). In some examples, the second imaging device 309-2 can be activated when the luminosity value at the subject 342 is within a luminosity range. In this way, relatively high-quality images can be captured by the second imaging device 309-2 when the plurality of light sources 312 are altered to a state that alters the luminosity values at the subject 342. Relatively high-quality images can be determined based on a luminosity at the subject. For example, a relatively high-quality image can include a subject that is represented by pixels that are within a particular luminosity range and a relatively low-quality image can include a subject that is represented by pixels that are either below the particular luminosity range or above the particular luminosity range. In other examples, different image properties can be selected to determine a quality of the image. For example, color can be selected to be utilized to determine image quality. In this example, a relatively high-quality image can include a subject that is represented by pixels that are within a particular color range and a relatively low-quality image can include a subject that is represented by pixels that are outside the particular color range. As described herein, the plurality of light sources 312 can be altered to a particular state to alter an image property such that the image property falls within the particular image property range defined by a relatively high-quality image.

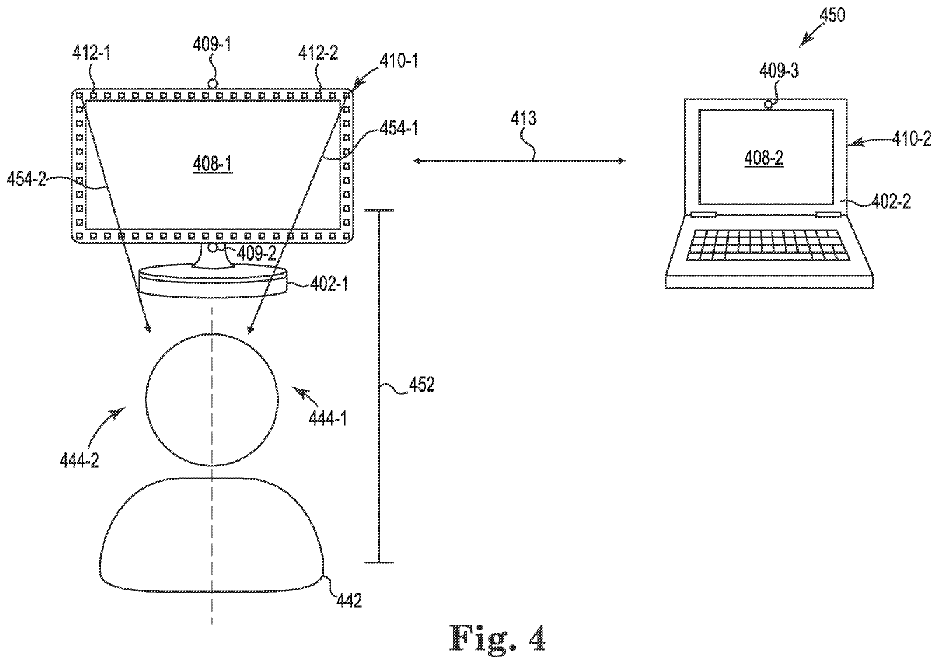

FIG. 4 illustrates a block diagram of an example system 450 for activating light sources 412-1, 412-2 for output images based on a subject 442. In some examples, the system 450 can include similar elements as system 100 as referenced in FIG. 1, and/or system 300 as referenced in FIG. 3. For example, the system 450 can include a first computing device 402-1 and a second computing device 402-2. In some examples, the first computing device 402-1 can include a memory resource storing instructions that can be executed by a processor resource similar to the memory resource 206 and processor resource 204 as referenced in FIG. 2.

As described herein, a display 408-1 can include an enclosure 410-1 that can be utilized to protect components of the display 408-1. In some examples, a plurality of light sources 412-1, 412-2 can be coupled to the enclosure 410-1. In some examples, the plurality of light sources 412-1, 412-2 can be permanently embedded within the enclosure 410-1 and/or coupled to a surface of the enclosure 410-1 such that the plurality of light sources 412-1, 412-2 can be removed from the display 408-1 and utilized by a different display. In a similar way, the second computing device 402-2 can include an image sensor 409-3 and/or a plurality of light sources similar to the first computing device 401-1. In this way, the second computing device 402-2 can utilize the image sensor 409-3 to determine a brightness level at a corresponding subject of the second computing device 402-2 and alter light sources based on the determined brightness level. That is, the plurality of light sources 412-1, 412-2 can be utilized by a desktop computer monitor as illustrated by the first computing device 402-1 and/or a laptop computer monitor as illustrated by the second computing device 402-2. In some examples, the plurality of light sources 412-1, 412-2 can be removable from the enclosure 410-1 and coupled to the enclosure 410-2. As described herein, when the plurality of light sources 412-1, 412-2 are moved from a first location to a second location (e.g., from a first enclosure 410-1 to a second enclosure 410-2, etc.), the corresponding computing device can determine a physical location for the plurality of light sources 412-1, 412-2 to determine portions of the plurality of light sources 412-1, 412-2 that correspond to portions 444-1, 444-2 of the subject 442.

In some examples, the system 450 can include a display 408-1 communicatively coupled to the first computing device 402-1. In some examples, the display 408-1 can display images generated by the first computing device 402-1 and/or received by the first computing device 402-1. In some examples, the first computing device 402-1 can be utilized to share output images with the second computing device 402-2 through a communication path 413. In this way, the output images generated by the computing device 402-1 through the first imaging device 409-1, second imaging device 409-2, and/or plurality of light sources 412-1, 412-2 can be displayed on the monitor 408-2 of the second computing device. For example, the first computing device 409-1 can be utilized to perform a video conference with the second computing device 409-2. In this example, the first computing device 402-1 can utilize an input image to generate a relatively higher quality output image that can be transferred to the second computing device 409-2 through the communication path 413.

As described herein, the first computing device 402-1 can instruct the first imaging device 409-1 to capture an input image. As described herein, the input image can include a depth map that can be utilized to determine a distance 452 between the subject 442 (e.g., user, human user, focus of the input image, etc.) and the first imaging device 409-1 and/or the plurality of light sources 412-1, 412-2. As described herein, the distance 452 can be utilized to determine a predicted effectiveness for the plurality of light sources 412-1, 412-2 on the subject 442. For example, a relatively greater distance 452 can result in relatively less effectiveness compared to a relatively shorter distance 452.

Thus, a brightness level of the plurality of light sources 412 can be altered based on the distance 452. For example, the brightness level of light emitted by the plurality of light sources 412-1, 412-2 can be increased when the distance 452 is relatively large and the brightness level of the light emitted by the plurality of light sources 412-1, 412-2 can be lowered when the distance 452 is relatively small. Thus, the brightness level for the plurality of light sources 412-1, 412-2 can be based on the distance 452 and the luminosity level at the subject 442.

In some examples, the input image captured by the first imaging device 409-1 can be split into a plurality of portions 444-1, 444-2. As described in reference to FIG. 3, the plurality of portions 444-1, 444-2 can include a greater quantity of portions or fewer portions than illustrated without departing from the present disclosure. In some examples, the plurality of portions 444-1, 444-2 can be utilized to identify a plurality of portions of light sources 412-1, 412-2. For example, a first portion 444-1 of the input image can correspond to a first portion of light sources 412-1 and a second portion 444-2 of the input image can correspond to a second portion of light sources 412-2. In this way, the first portion of light sources 412-1 can be utilized to alter a luminosity of the first portion 444-1 of the input image and the second portion of light sources 412-2 can be utilized to alter a luminosity of the second portion 444-2 of the input image,

In some examples, the first portion of light sources 412-1 can be directed in a first direction 454-1 and the second portion of light sources 412-2 can be directed in a second direction 454-2. For example, the first portion of the light sources 412-1 can be directed toward the first portion 444-1 of the subject 442 and the second portion of light sources 412-2 can be directed toward the second portion 444-2 of the subject. In this way, the plurality of light sources 412-1, 412-2 can be split into portions that correspond to the portions 444-1, 444-2 of the image and/or subject 442. Thus, the portion of the plurality of light sources 412-1, 412-2 can be identified based on a direction of light emitted by the plurality of light sources 412-1, 412-2.

In some examples, the first portion of light sources 412-1 can have a first color, intensity, and/or other properties and the second portion of light sources 412-2 can have a second color, intensity and/or other properties that are different than the first portion of the light sources 412-1. For example, the first portion of light sources 412-1 can be a first color and can be activated when the first color is determined to increase an image quality at the subject 442. In this example, the second portion of light sources 412-2 can be a second color and can be activated when the second color is determined to increase the image quality at the subject 442

In some examples, the first computing device 402-1 can apply image correction to captured video of the subject 442 based on the luminosity value at the subject 442. As used herein, image correction refers to instructions that can be executed by a processor resource to alter image properties of an image. For example, the image correction that is applied can remove a red color from eyes, increase a brightness of a shadow, optimize a contrast, optimize a saturation, fix or adjust for shaking, fix or adjust for resolution, and/or decrease brightness of ambient light. In some examples, the image correction can be applied together with altering the state of the plurality of light sources 412-1, 412-2. For example, the plurality of light sources 412-1, 412-2 can be activated to increase a luminosity at the subject 442. In this example, the first computing device 402-1 can determine that the luminosity is within a particular luminosity range before performing the image correction. In this example, the luminosity range can be a range of luminosity values that can be fixed or altered by the image correction.

In some examples, the first computing device 402-1 can utilize a feedback loop to increase the image quality of an input image. For example, the first computing device 402-1 can alter a state of the first portion of light sources 412-1 to increase a luminosity at the first portion 444-1 of the subject 442. In this example, the first imaging device 409-1 can capture a first input image to determine if the first portion 444-1 of the subject 442 is within a range of luminosity levels. In this example, the first computing device 402-1 can increase a brightness level of the first portion of light sources 412-1 when the luminosity of the first portion 444-1 of the subject is below a luminosity threshold or outside the luminosity range. In this example, the first imaging device 409-1 can capture a second input image to determine if the first portion 444-1 of the subject 442 is within the luminosity range. In this way, a feedback loop can update input images until the portions of the input image is within the luminosity range.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processor resource; and
a non-transitory memory resource storing machine-readable instructions stored thereon that, when executed, cause the processor resource to:
instruct an imaging device to capture a first image;
determine an image property of the first image;
activate a portion of a plurality of light sources based on a physical location of the plurality of light sources and the determined image property of the first image; and
instruct the imaging device to capture a second image when the portion of the plurality of light sources are activated.

2. The computing device of claim 1, wherein the processor resource is to transmit the second image to a different computing device utilizing a communication path and restrict the first image from being transmitted to the different computing device.

3. The computing device of claim 1, wherein the image property of the first image includes a distance of a subject from the imaging device and identified shadowing on the subject.

4. The computing device of claim 3, wherein the processor resource is to:
determine an intensity, state, and direction for the plurality of light sources based on the distance of the subject from the imaging device and the identified shadowing on the subject; and
cause the portion of the plurality of light sources to alter a state based on the determined intensity, state, and direction for the plurality of light sources and the image property of the first image, wherein the state includes a brightness level, color, and tone of the plurality of light sources.

5. The computing device of claim 4, wherein the processor resource is to activate the portion of the portion of the plurality of light sources to the determine intensity.

6. The computing device of claim 4, wherein the portion of the plurality of light sources are selected based on a direction of light emitted from the portion of the plurality of light sources.

7. The computing device of claim 1, wherein the processor resource is to alter a state of the portion of the plurality of light sources based on a determined color tone of a subject.

8. A non-transitory memory resource storing machine-readable instructions stored thereon that, when executed, cause the processor resource to:
instruct a first imaging device to capture a first image of a subject;
determine image properties of the first image, wherein the image properties include brightness, color tone of the subject, and distance between the subject and a second imaging device;
activate a first portion of a plurality of light sources at a first location surrounding a display device based on portions of the first image below a brightness threshold;
deactivate a second portion of the plurality of light sources at a second location surrounding the display device based on portions of the first image above a brightness threshold; and
instruct a second imaging device to capture a second image with the activated first portion and deactivated second portion of the plurality of lights to be provided to a remote device as an image feed.

9. The medium of claim 8, wherein the first imaging device is a proxy imaging device and the second imaging device is a real imaging device.

10. The medium of claim 8, wherein the processor resource is to determine a luminosity at a plurality of locations of the subject.

11. The medium of claim 10, wherein the processor resource is to determine a brightness and color of the first portion of the plurality of light sources based on the luminosity at the plurality of locations of the subject.

12. A system, comprising:
a display device including an enclosure that surrounds a display area of the display device;
a plurality of light sources coupled to the enclosure;
an imaging device to capture an image of a subject
a processor resource to:
identify portions of the image of the subject that correspond to the plurality of light sources coupled to the enclosure;
identify portions of the plurality of light sources that correspond to the identified portions of the image;
determine a particular portion of the image that has a luminosity value at the subject that is below a luminosity threshold;
activate a corresponding portion of the plurality of light sources based on the luminosity level at the subject;
instruct the imaging device to capture video of the subject when a luminosity value at the subject are within a luminosity range for the identified portions of the image.

13. The system of claim 12, wherein processor resource is to transmit the video to a remote device while the video includes the luminosity value at the subject that is within the luminosity range.

14. The system of claim 12, wherein the processor resource is to alter a color tone of the corresponding portion of the plurality of light sources to an adjustment color tone based on the subject.

15. The method of claim 12, wherein the processor resource is to apply image correction to the captured video of the subject when the luminosity value at the subject is within the luminosity range.
